(19) United States
(12) Patent Application Publication
(10) Pub. No.: US 2026/0255216 A1
(43) Pub. Date: Aug. 27, 2026

(54) METHOD FOR CONCATENATED TRANSMISSION FOR ULTRA-RELIABLE LOW-LATENCY COMMUNICATION

(71) Applicant: Continental Automotive Technologies GmbH, Hannover (DE)

(72) Inventors: Hojin Kim, Regensburg (DE); David Gonzalez Gonzalez, Egelsbach (DE); Reuben George Stephen, Singapore (SG); Rikin Shah, Langen (DE); Andreas Andrae, Frankfurt am Main (DE); Shravan Kumar Kalyankar, Singapore (SG); Osvaldo Gonsa, Frankfurt (DE)

(73) Assignee: Continental Automotive Technologies GmbH, Hannover (DE)

(21) Appl. No.: 18/726,812

(22) PCT Filed: Jan. 3, 2023
(86) PCT No.: PCT/EP2023/050068

§ 371 Date: Jul. 4, 2024

(30) Foreign Application Priority Data
Jan. 4, 2022 (DE) 10 2022 200 016.1

(51) Int. Cl. H04W 28/06; H04W 28/02

(52) U.S. Cl. CPC H04W 28/065; H04W 28/0268

(57) ABSTRACT

An apparatus configured to be employed within a multiple transmission and reception point (multi-TRP) interacting with user equipments (UE) for ultra-reliable low-latency communication in a wireless communication system, including one or more processors with at least a memory configured to generate a Media Access Control (MAC) protocol data payload including a sequence of a set of IP packets (PacketN) for a set of user equipments (UEs), wherein one member of the sequence of a set of IP packets (PacketN) of a set of user equipments (UEs) are a sequence of multiple Media Access Control sub protocol data units (MAC subPDUs) for concatenated user equipment (UE) packets, attach a MAC header to the MAC data field to generate a packet data unit (PDU), wherein the MAC header indicates, if the Media Access Control (MAC) protocol data payload field is a concatenated payload field.

### CROSS-REFERENCE TO RELATED APPLICATIONS

The present application is a National Stage Application under 35 U.S.C. § 371 of International Patent Application No. PCT/EP 2023/050068 filed on Jan. 3, 2023, and claims priority from German Patent Application No. 10 2022 200 016.1 filed on Jan. 4, 2022, in the German Patent and Trademark Office, the disclosures of which are herein incorporated by reference in their entireties.

### TECHNICAL FIELD

The invention relates to a decentralized method for concatenated transmission for ultra-reliable low-latency communication, an apparatus to perform the method and a wireless communication system.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, and/or the like.

The above multiple access technologies have been adopted in various telecommunication standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

Ultra-reliable low latency communications (uRLLC) 5G is one of three fifth-generation 5G mobile communications service categories defined by the ITU.

Massive Machine Type Communications is one of several application profiles planned for fifth-generation (5G) mobile networks. mMTC supports a large number of connected devices from the field of machine-to-machine communication and the Internet of Things (IoT). An important requirement here is the high energy efficiency for mobile devices.

The abbreviation mMTC stands for Massive Machine Type Communications (mMTC). It is one of currently three defined application profiles for 5G mobile networks. The profile is intended for use cases where a huge number of devices or components of machine-to-machine communication and the Internet of Things (IoT) are interconnected.

The devices send data rather sporadically and should be cheap to produce. Mobile communication must be energy-efficient and possible in a wide variety of locations. Devices such as sensors or smart meters in energy networks do not have their own permanent power supply and should remain operable with batteries or accumulators for long periods of time. In addition, the devices are often installed in places such as basements or production halls, which must be reliably supplied with mobile radio technology. Typical applications include sensor networks, networked machines, wearables or autonomous, networked robotics.

The 3rd Generation Partnership Project (3GPP) has examined the different use cases and divided them into three central application profiles for 5G networks.

These profiles are:
mMTC (Massive Machine Type Communications)
eMBB (Enhanced Mobile Broadband)
uRLLC (Ultra Reliable and Low Latency Communications)

The URRLLC application profile has high requirements in terms of short response times, reliability and availability. It is intended for time-critical applications such as autonomous driving. Use cases that fall into the eMBB application profile require high transfer rates and large capacity in relation to a certain unit of area. Typical use cases are virtual and augmented reality or the mass streaming of high-or ultra-high-resolution videos.

Essentially, Massive Machine Type Communications has the following requirements for the mobile network:
Support for high device density per unit area
Low energy consumption of the end devices ~i.e. long usage times in battery or accumulator operation
inexpensive in terminal equipment production
Reliable mobile coverage even in unfavourable locations
fully autonomous operation of the devices
Long-term availability of mobile communications technology

URLLC is considered one of the key scenarios for 5G mobile communications. High reliability and low latency requirements are coupled, enabling connectivity for new industrial services and applications such as factory automation. Ultra-reliable”, i.e. highly reliable or fail-safe, refers to a connection that meets a connection probability greater than 99.999% and thus corresponds to the connection security of a wired connection. The target latency for uRLLC at user level is 0.5 ms in both uplink and downlink. Due to the high demands on availability and latency, uRLLC requires special quality assurance measures. A practical example from industry illustrates the requirements, that the haptic control of an actuator such as a robot arm takes less than 10 ms.

Ultra-reliable and low-latency communication (URLLC) is, as mentioned, one of key service areas introduced in 5G along with other major ones such as enhanced mobile broadband (eMBB) and machine-type communication (MTC). URLLC contains many important applications and use cases. Some of them include intelligent transportation, autonomous driving, industrial/process automation, tactile internet, tele-surgery, virtual/augmented reality, etc. Support of URLLC services needs the stringent requirement for high reliability and/or low latency. To reduce latency, short packet size is introduced for URLLC. Due to short packet size, reliability is sacrificed by keeping low latency and radio resources are used inefficiently. Depending on network traffic load conditions, heavy signaling traffic overhead is another key challenge.

Short packet size for URLLC applications require high SNR to meet low error rate.

As shown in in FIG. 2 the graph shows longer packet size reduces the required SNR for target error rate. With lower target error rate, the packet size increase in the low bit length provides higher SNR gain.

Fredrik Persson, “Voice over IP Realized for the 3GPP Long Term Evolution,” 2007 IEEE 66th Vehicular Technology Conference, 2007. This document describes by utilizing concatenation of voice packets over the radio substantial capacity gains are possible derived from both decreased protocol overhead and fewer transmitted signaling messages

Ramya Raghavendra, Amit P. Jardosh, Elizabeth M. Belding, Haitao Zheng, “IPAC: IP-based Adaptive Packet Concatenation for Multihop Wireless Networks,” 2006 Fortieth Asilomar Conference on Signals, Systems and Computers, 2006. This paper describes the reduction of contention through concatenation of several small packets into a single large packet, and subsequently transmit this large packet

Wei-chih Hong, Zsehong Tsai, “A Multichannel Scheduler for High-Speed Wireless Backhaul Links with Packet Concatenation,” IEEE Transactions on Mobile Computing, Volume: 9, Issue: 2, 2010. This paper porposes a scheduler that concatenates small packets into large frames and sends them through multiple parallel channels with an intelligent channel selection algorithm between neighboring nodes

Ting-Chu Lee, Zsehong Tsai, “On the Capacity of Smart Grid Wireless Backhaul With Delay Guarantee and Packet Concatenation,” IEEE Systems Journal, Volume: 11, Issue: 4, 2017. Low channel efficiency due to small data payloads and the delay guarantee of many near-real-time applications would become two important issues. In this paper, it is proposed to employ a deadline-ordered scheduler with packet concatenation and apply admission control (AC) to resolve these two issues

Seyoung Ahn, Teasung Kim, Yongseok Kwon, Sunghyun Cho, “Packet Aggregation Scheme to Mitigate the Network Congestion in Blockchain Networks,” 2020 International Conference on Electronics, Information, and Communication (ICEIC), 2020. C-mode concatenates packets into the single packet. X-mode exploits exclusive-or (XOR) operation to combine two packets into one packet

Sung-Jin Ok, Jung-Ha Kang, Eum-Gi Kim, “Wireless LAN packet concatenation algorithm,” Second International Conference on Future Generation Communication Technologies (FGCT 2013), 2013. This paper proposes IP packet concatenation methods that are able to merge two or more IP packets with same destination addresses into a MPDU.

US 2020154467 discloses control information for scheduling a transmission resource for downlink and uplink communications between one or more TRP and one or more UE. One Physical Downlink Control Channel (PDCCH) for DL control information transmission is assumed to carry at least one assignment or scheduling information block for at least one Physical Downlink Shared Channel (PDSCH) for DL data transmission or for at least one Physical Uplink Shared Channel (PUSCH) for UL data transmission.

Embodiments of the present application provide methods of providing configuration information that can be used by a user equipment (UE) to determine transmission mode for the PDSCH and PUSCH as well as information to determine where to monitor for the PDSCH, PUSCH and PUCCH information.

US 2021058818 discloses concatenation of service data units above a packet data convergence protocol layer and discloses an apparatus of a cellular data communication device includes one or more memory devices configured to store data corresponding to a plurality of service data units (SDUs) from a protocol layer higher than a packet data convergence protocol (PDCP) layer of a cellular data network, and one or more processors operably coupled to the one or more memory devices and configured to concatenate the plurality of SDUs into a single protocol data unit (PDU) above the PDCP layer.

WO 2017171910 discloses a packet data convergence protocol (PDCP) concatenation for high data rate. One or more PDCP service data units (SDUs) can be concatenated into a single PDCP packet data unit (PDU), and/or one or more PDCP SDUs can be reassembled for in order delivery from a single PDCP PDU. In various embodiments, the PDCP header can be modified to indicate concatenated data field elements from the one or more PDCP SDUs.

US 2018083874 discloses a broadcast signal receiving apparatus and broadcast signal receiving method. An apparatus for receiving a broadcast signal, the apparatus includes a tuner configured to receive a broadcast signal; and a hardware processor configured to: process the broadcast signal to output a link layer packet, decapsulate the link layer packet to output a plurality of output packets comprising service data for a broadcast service, and decode the output packets to output the service data for the broadcast service, wherein the link layer packet includes a header and a payload including the service data of the output packets, wherein the header includes a base header having a first length field, wherein the header further includes an additional header for concatenation and the payload includes concatenated output packets, the additional header includes a second length field, and a concatenation of the first length field and the second length field indicates a total length of the payload.

U.S. Pat. No. 11,057,153 describes multi-user data packet and provide techniques for a multi-user data packet, such as a physical downlink shared channel (PDSCH) packet. A method by a base station (BS) includes sending a control channel, such as physical downlink control channel (PDCCH), scheduling a plurality of user equipment (UEs) for a data packet transmission and sending data for the plurality of UEs in a single transport block on the scheduled data packet. The UE receives the control channel and data packet and determines the data in the multi-user data packet that is intended for the UE.

US 2007060139 discloses a method and apparatus for enabling efficient use of radio resources by reducing an RLC PDU size in a mobile communication system supporting voice service over a packet network are provided. An RLC layer constructs an RLC PDU without inserting information indicating the start and end of an SDU or indicating the use or non-use of padding. The RLC layer sets an LI in a header to indicate inclusion of an intermediate SDU segment in the data field of the RLC PDU. Therefore, the resulting decrease of overhead arising from packet transmission facilitates the efficient use of limited radio resources.

U.S. Pat. No. 10,999,007 describes that a user equipment (UE) may receive a plurality of communications from a corresponding plurality of transmission/reception points (TRPs) included in a coordinated multipoint network. At least two communications, of the plurality of communications, may have different redundancy versions from a common codebook, and may be received in a same transmission time interval (TTI). The UE may decode the plurality of communications using joint decoding. Numerous other aspects are provided.

The concept of packet concatenation has been adopted for reliability improvement as addressed in the listed references. Some of them covered some specific application-based concatenation scheduling and/or packet structure.

In the listed prior art references, it has not been specified about end-to-end operation system for the overall packet concatenation mechanism associated with specific QoS/MAC scheduling combined with the specified packet structure altogether. Most importantly, this application is mainly focused on multi-TRP based concatenation transmission method that has not been addressed in any prior art.

Major advantages of this invention are summarized as follows.

Signaling traffic overhead reduction: As multi-TRP based data duplication transmission results in signaling traffic overhead increase, the overall network capacity and resource utilization efficiency are impacted at the expense of spatial diversity provided by multi-TRP. By concatenating multiple packets in the same transport block within any given transmit time interval for multi-TRP based transmission, the overall signaling traffic can be significantly reduced for both control and data channels. The amount of signaling traffic overhead reduction depends on the degree of concatenation level and network traffic load conditions. The higher concatenation level provides better signaling traffic condition for radio access network.

Reliability performance enhancement: Short packet transmission helps lower latency, but its reliability performance fundamentally is degraded due to short packet size. Then it requires high SNR to meet low error rate for URLLC applications. The proposed multi-mode concatenation transmission method provides high SNR gain by combining activation of concatenation and duplication of data packets with multi-TRP.

Multi-TRP based spatial diversity sacrifices additional resource to be used by transmitting the duplicated data through multiple links. However, the proposed multi-mode concatenation transmission method provides better utilization of radio resource based on channel link quality conditions by transmitting mixture of duplicated and non-duplicated data packets in the same transport block within the transmit time interval. Hence, radio resource can be used more efficiently based on the combination of activations for duplication and concatenation transmissions. Resource utilization efficiency improvement:

The invention is useful in Cellular networks, particularly wireless communication systems, e.g., 5G+ and 6G, where multi-TRP and short packet transmission such as URLLC are standardized and further enhanced for radio access network.

### BREIF SUMMARY

This invention proposes a new mechanism of concatenated transmission for multi-TRP network as multi-TRP is one of key areas in 5G and beyond for many applications areas, including URLLC. It is known that Multi-TRP provides spatial diversity for short packet transmissions that require low latency and high reliability, but it then causes heavy signaling traffic overhead with inefficient resource utilization while diversity gain can be achieved. Therefore, the proposed mechanism tackles heavy signaling traffic overhead for reduction while spatial diversity gain from multi-TRP can be still maintained for support in all relevant applications.

The summarized contributions for this invention are as follows:
Multi-TRP based concatenation transmission mechanism
3GPP specific packet header structure for concatenation

Concatenation scheduling combining QoS classification and MAC scheduling

The solution employs the concept of packet concatenation and is mainly focused on multi-TRP deployment scenario to use concatenation transmission by proposing multiple modes with a combination of TRPs, duplication, and concatenation.

For the proposed methods, the following items are described in detail for support of concatenation transmission mechanism.
1. Concatenation packet format
2. Concatenation scheduling method
3. Multi-TRP based multi-mode concatenation transmissions

The described problem is solved by one embodiment of an apparatus configured to be employed within a multiple transmission and reception point (multi-TRP) interacting with user equipments (UE) for ultra-reliable low-latency communication in a wireless communication system, comprising one or more processors with at least a memory configured to generate a Media Access Control (MAC) protocol data payload comprising a sequence of a set of IP packets (PacketN) for a set of user equipments (UEs), wherein one member of the sequence of a set of IP packets (PacketN) of a set of user equipments (UEs) are a sequence of multiple Media Access Control sub protocol data units (MAC subPDUs) for concatenated user equipment (UE) packets, attach a MAC header to the MAC data field to generate a packet data unit (PDU), wherein the MAC header indicates, if the Media Access Control (MAC) protocol data payload field is a concatenated payload field.

Another embodiment is characterized by an apparatus, characterized by, that the MAC header indicates the number of the concatenated packets for multiple Media Access Control sub protocol data units (MAC subPDUs).

Another embodiment is characterized by an apparatus, characterized by, that the MAC header indicates a length field size of concatenated payload field.

Another embodiment is characterized by an apparatus, that the MAC header indicates length of corresponding concatenated multiple Media Access Control sub protocol data units (MAC subPDUs) belonging to each user equipment (UE).

Another embodiment is characterized by an apparatus, characterized by, that the MAC header identifies concatenation format index.

Another embodiment is characterized by an apparatus, that the MAC header identifies concatenation size or number of concatenated packets.

Another embodiment is characterized by an apparatus, characterized by, that the MAC header identifies group user equipment's (UEs) contained in the concatenated packets.

The described problem is solved by one embodiment of a method for concatenating data packets for ultra-reliable low-latency communication in a wireless communication system with transmission and receiver points (TRP), the method comprising the steps, monitoring transmits packet buffer queue for different user equipment (UE), classifying buffered packets of each user equipment (UEs) based on associated quality of service profile index, setting the concatenation packet group buffer time limit by establishing a concatenation packet timer based on the associated quality of service (QOS) profile index and (RRC) configuration signaling, determining the target classified packet group (PGQ) for candidate concatenation transmission, regrouping packet group (PGQ) for using the same modulation coding scheme MCS index (PGM) based on each user equipment (UE) feedback information checking if regrouping packet group (PGM) is available, wherein when regrouping packet group (PGM) is not available scheduling packets without concatenation for regrouping packet group (PGQ) is proceeded, wherein when regrouping packet group (PGM) is available selecting regrouping packet group (PGM) for transmission based on the measured metric for selection criteria is proceeded, determination of transport block size threshold (TBT) for transmission based on the-schedule resource and/or buffered data, checking if regrouping packet group (PGM) is smaller or equals of the block size threshold (TBT) and if regrouping packet group (PGM) is smaller or equals of the block size threshold (TBT) forming a transport block for downlink transmission to target user equipment (UE) group with concatenated data packets.

Another embodiment is characterized by that based on the queued packet buffer with different UEs, Quality of Service (QOS) profile based packet classification proceeds.

Another embodiment is characterized by that concatenation packet timer is set, that the buffer packets for concatenation grouping is timely transmitted after the limited delay time.

Another embodiment is characterized by that, the candidate packet group (PGQ) is selected based on the pre-determined quality of service profile index to be used for concatenation.

Another embodiment is characterized by that, the feedback information is Chanel State information (CSI).

Another embodiment is characterized by that, the selection criteria are the Modulation Coding Scheme (MCS).

Another embodiment is characterized by that, the selection criteria are the Modulation Coding Scheme (MCS).

Another embodiment is characterized by that, the selection criteria are the Modulation Coding Scheme (MCS).

Another embodiment is characterized by that, the selection criteria highest priority level.

Another embodiment is characterized by that, the selection criteria the maximum of Modulation Coding Scheme (MCS) level.

Another embodiment is characterized by that, the selection criteria are maximum number of packets in concatenation Another embodiment is characterized by that, among candidate packet group with same modulation coding scheme (MCS) index for use, target packet group is chosen for concatenation transmission based on the pre-determined criteria.

20. Method according to claim 8 or 19 characterized by that, a packet group buffer time is set as time threshold value to secure that concatenation transmission is complete before this packet group buffer time threshold expires.

The described problem is solved by one embodiment of a method for trigerring a concatenated transmission for ultra-reliable low-latency communication in a wireless communication system with transmission and receiver points (TRP), performing the steps
monitoring traffic load status (TS) with periodic time,
measure traffic load level (TL) based on the pre-determined threshold (TLₜₕ)
triggering concatenation scheduling event if traffic load level (TL) exceeds pre-determined threshold (TLₜₕ)
activating method for concatenating data packets according to the claims 8 to 20.

Another embodiment is characterized by, that traffic load status is based on the data buffer volume and/or signaling traffic and/or transmission delay.

The described problem is solved by one embodiment of a method for concatenated transmission for ultra-reliable low-latency communication between two layers in a wireless communication system with transmission and receiver points (TRP), the method performing, if base-station for Media Access Control (MAC)-Layer (gNB MAC) performs concatenation among user equipments (UEs), base-station for Media Access Control (MAC)-Layer (gNB MAC) provides indication of concatenation in Media Access Control (MAC) layer to base station for physical-Layer (gNB PHY) and base station for physical-Layer (gNB PHY) sends concatenation packet through multi transmission and receiver points (multi-TRP).

The described problem is solved by another embodiment of a method for concatenated transmission for ultra-reliable low-latency communication in a wireless communication system with transmission and receiver points (TRP), performing the steps, receiving channel quality indicator (CQI) information is for user equipment whose packets are to be concatenated as candidate, comparing channel quality indicator measures (CQI_{UE}) to target channel quality indicator (CQI_{TH}) threshold for user equipment (UE)s wherein when channel quality indicator measures (CQI_{UE}) are higher than target channel quality indicator (CQI_{TH}), determining user equipment (UE) packets for sub packet group for single transmission (SPG_{ST}) whose channel quality indicator measures (CQI_{UE}) are not lower than to target channel quality indicator (CQI_{TH}) threshold, comparing channel quality indicator (CQI) measures measured between the transmission and receiver points A (TRP_{A}) (CQI_{UE} TRP_{A}) and the transmission and receiver point B (TRP_{B}) (CQI_{UE} TRP_{A}) for user equipment (UE) packets in single transmission (SPG_{ST}), wherein when channel quality indicator (CQI) measures measured between the transmission and receiver points A (TRP_{A}) (CQI_{UE} TRP_{A}) are lower than channel quality indicator (CQI) measures measured between the transmission and receiver point B (TRP_{B}) (CQI_{UE} TRP_{A}) schedule user equipment (UE) packets to be grouped in single transmission (SPG_{ST}) for the transmission and receiver point B (TRP_{B}) and assigning any overflow packets for next concatenation based on channel quality indicator (CQI) measure wherein when channel quality indicator (CQI) measures measured between the transmission and receiver points A (TRP_{A}) (CQI_{UE} TRP_{A}) are higher than channel quality indicator (CQI) measures measured between the transmission and receiver point B (TRP_{B}) (CQI_{UE} TRP_{A}), scheduling user equipment (UE) packets to be grouped in packet group for single transmission (SPG_{ST}) for transmission and receiver point A (TRP_{A}) and assign any overflow packet for next concatenation based on channel quality indicator (CQI) measure, forming transport block based on the determined packet group for multi transmission (SPG_{MT}) and for single transmission (SPG_{ST}) for transmission and receiver point A (TRP_{A}) and transmission and receiver point B (TRP_{B}).

Another embodiment is characterized by, receiving channel quality indicator (CQI) information is for user equipment whose packets are to be concatenated as candidate comparing channel quality indicator measures (CQI_{UE}) to target channel quality indicator (CQI_{TH}) threshold for user equipment (UE)s if channel quality indicator measures (CQI_{UE}) are lower than target channel quality indicator (CQI_{TH}) determining the user equipment (UI) packets for single transmission (SPG_{ST}), whose channel quality indicator measures (CQI_{UE}) are lower than target channel quality indicator (CQI_{TH}) scheduling user equipment (UE) packets to be grouped in multi transmission (SPG_{MT}) and assign any overflowed packets for next concatenation based on the channel quality indicator (CQI) measure, forming transport block based on the determined packet group for multi transmission (SPG_{MT}) and for single transmission (SPG_{ST}) for transmission and receiver point A (TRP_{A}) and transmission and receiver point B (TRP_{B}).

The described problem is solved by a embodiment of a method for concatenated transmission path selection for ultra-reliable low-latency communication in a wireless communication system with transmission and receiver points (TRP), the method comprises the steps, receiving channel quality indicator (CQI) information for user equipments (UEs)) which are to be concatenated as candidate, comparing channel quality indicator (CQI) measures (CQI_{UE}) to target channel quality indicator (CQI) threshold (CQIth) for user equipments (UEs), determining user equipment (UE) packets for transmission and receiver points (TRP) selection comparing the combined channel quality indicator (CQI) measure for the grouped user equipments (UEs) between transmission and receiver points (TRP) A (TRP_{A}) and B (TRP_{B}) wherein when the sum of channel quality indicator (CQI) measures (CQI_{UE}) for transmission and receiver points A (TRP_{A}) is higher than CQI measures (CQI_{UE}) for transmission and receiver points B (TRP_{B}), selecting transmission and receiver points A (TRP_{A}) for downlink transmission of the concatenated packet group, otherwise selecting transmission and receiver points A (TRP_{B}) for downlink transmission of the concatenated packet group, transmitting concatenated packet group in Physical Data Shared Channel (PDSCH) from the selected transmission and receiver points (TRP).

The described problem is also solved by a wireless communication system including base stations (gNB), multi transmission and receiver point (TRP) communicating with a user equipment (UE), wherein the base station, transmission and receiver points and user equipment's (UE) comprising processor coupled with a memory in which computer program instructions are stored, wherein multi transmission and receiver point (TRP) performing downlink (DL) data transmission to multiple user equipments (UEs) for ultra-reliable low-latency communication (URLLC) application-based packets for downlink (DL) data transmission, multi transmission and receiver point (TRP) with the apparatus according to claims 1 to 8 concatenates multiple packets intended for a group of user equipments (UEs) multiple UEs are located for downlink data reception from multi transmission and receiver point (TRP) for URLLC applications target user equipments (UE) packets for concatenation are selected based on packet concatenation method according to the claims 8 to 21, wherein the transmission between user equipments (UEs) groups and multi transmission and receiver point (TRP) is proceed by executing the method according to the claims 23 to 25 and the path selection for the transmission between user equipments (UEs) groups and multi transmission and receiver point (TRP) is proceeded according to the claim 26.

The described problem is also solved by computer program product, comprising commands which, when executed by a computer, cause it to execute the method according to one or more of claims 1-26.

The described problem is also solved by computer-readable data carrier on which the computer program product according to claims 28 is stored.

The following description assumes that each of the network devices in a group of network devices can receive messages from all other network devices in the group. For this purpose, the network devices may be located at a distance that allows direct communication with each other, but it is also possible to route the communication of the network devices via one or more transmit/receive points (TRPs) acting as repeaters, so that a group exists even if not all network devices can communicate directly with all other network devices in the group. The repeaters can also be connected to each other via another network by type of access point. Receiving messages from other network devices is also referred to as “listening” or “monitoring” in the following description.

Every network device or user equipment (UE), regardless of whether it belongs to a group or not, has a unique identifier or identification assigned to it, e.g., a MAC address. In addition, each network device or user equipment (UE) has at least one interface set up for bidirectional communication.

In the present description, the term type of use is used, among other things, for the type of transmission within a time slot, here especially the modulation and coding scheme (MCS). However, the term type of use can also describe the type of messages sent in a time slot, e.g., messages that are necessary for network management. Such messages can be given special consideration in the allocation of resources, e.g., not counted towards the “access budget” of a network device or the like. The type of use can be predetermined for certain time slots.

A user equipment (UE) set up to control broadcast access to a communication medium shared by network devices includes a communication interface set up to optionally access the shared communication medium. Optional access includes sending or receiving messages or transmissions over the shared communication medium. The user equipment (UE) also includes a timer module that can be set by a synchronization signal fed to the network device. The synchronization signal can, for example, be supplied by a receiver of a satellite navigation system coupled to the network device, or by a receiver that wirelessly receives a signal of a time reference. The network device also includes a microprocessor and volatile and/or non-volatile memory associated with it. The memory contains computer program instructions which, when executed by the microprocessor, execute one or more embodiments and further developments of the method described above.

A computer program product according to the invention contains accordingly commands which, when executed by a computer, cause it to execute one or more embodiments and further developments of the method described above.

The computer program product may be stored on a computer-readable medium. The data carrier may be physically embodied, for example as a hard disk, CD, DVD, flash memory or the like, but the data carrier may also include a modulated electrical, electromagnetic or optical signal that can be received by a computer by means of a corresponding receiver and stored in the memory of the computer.

A vehicle with a network device according to the invention can form a group with other suitably equipped vehicles that are within communication range, which exchange messages or information via a shared communication medium, for example about a condition of a roadway or dangerous situations located on a road ahead. In this case, land, air or water vehicles can communicate equally with each other, provided that they have a network device according to the invention. For example, drones in the airspace above a road can transmit information about the road to cars or trucks. In addition, a fixed device on a road or other location may be used to form a group with vehicles in range, at least temporarily, e. B to exchange messages or information via a shared communication medium.

### BRIEF DESCRIPTION OF THE DRAWINGS

In the following, the invention is explained in more detail on the basis of the embodiments with reference to the accompanying figures. All figures are purely schematic and not scaled.

FIG. 1 shows a short data packet for a URLLC payload with header.

FIG. 2 shows the approach of the method.

FIG. 3 shows multi-transmission and reception point (multi-TRP) for all UEs in a network.

FIG. 4 shows the system architecture in a wireless communication system.

FIG. 5 shows Data Packet Concatenation packet format.

FIG. 6 shows Data Packet Concatenation coding gain.

FIG. 7 shows MAC PDU structure for packet concatenation.

FIG. 8 shows QoS-MAC scheduling flow.

FIG. 9 shows the flow chart for the data packet concatenation process.

FIG. 10 shows the concatenation triggering flow.

FIG. 11 shows Sub-packet grouping for multi-TRP concatenation.

FIG. 12 shows Concatenation Transmission method for multi TRP.

FIG. 13 shows the flow for Concatenation Transmission method for multi TRP.

FIG. 14 shows the messaging method for the flow for Concatenation Transmission method for multi TRP.

FIG. 15 shows the TRP path selection of Multi-TRP for concatenated transmission.

FIG. 16 shows the Multi-Mode Concatenation Transmissions modes.

FIG. 17 shows the flow for Multi-Mode Concatenation Transmissions.

FIG. 18 shows the Configured/Dynamic Scheduling Scenarios.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

The same or similar elements are provided with the same or similar reference signs in the figures.

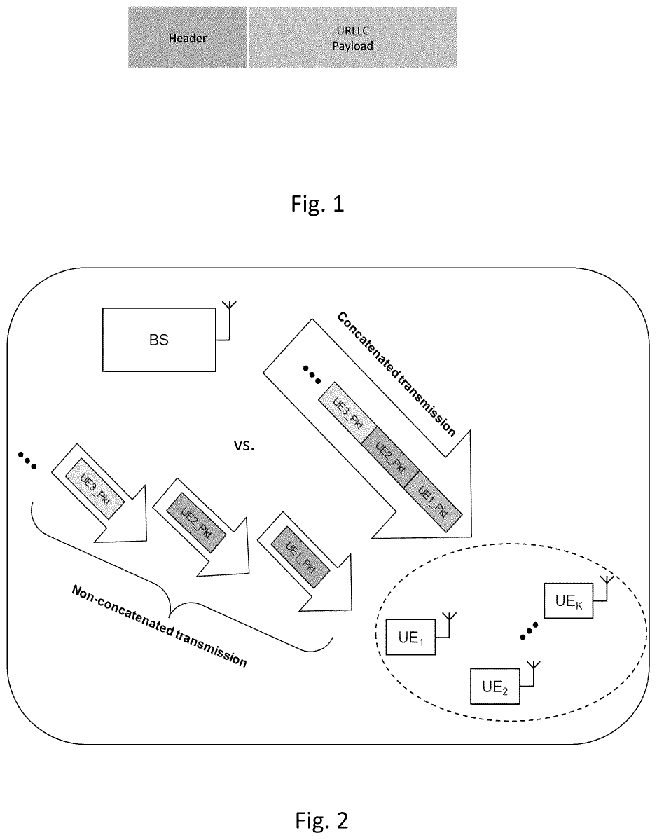

FIG. 1 shows a short packet size with a header and an URLLC payload.

FIG. 2 shows the approach of the method. Packets for URLLC applications tend to have short payload size and high portion of header in overall packet size. Generally spoken the invention reduces the packet signaling traffic overhead for URLLC scenarios by short packet aggregation or concatenation.

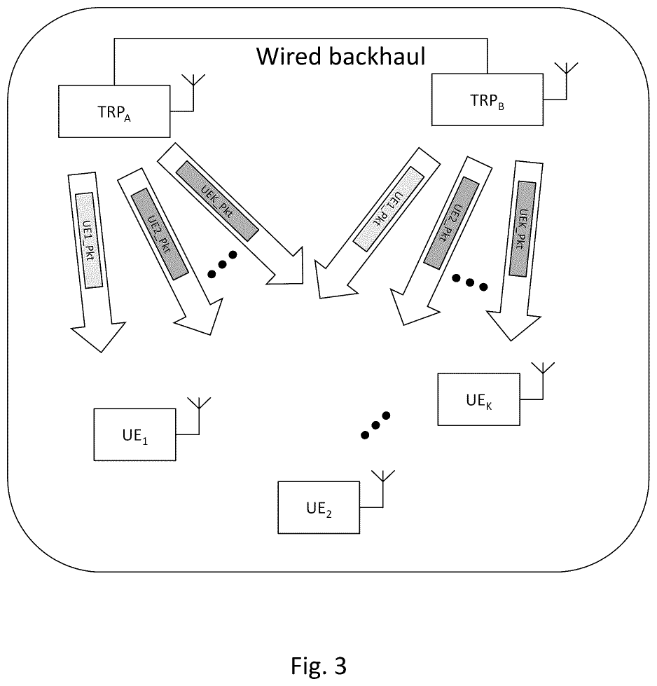

FIG. 3 shows multi-TRP (transmission and reception point) for all UEs in a network. For URLLC, multi-TRP (transmission and reception point) provides spatial diversity for UEs in downlink by transmitting the same data packets through multiple TRPs.

UEs can perform soft combining of the received data packets from multiple TRPs by considering different link quality conditions between TRPs and UEs.

However, these URLLC packet transmissions cause heavy signaling traffic with data and control channels. Inefficient resource use, Signaling traffic overhead. The inventive solution here is short packet aggregation or concatenation. The network may include multiple TRPs deployed at various geographical locations. The TRPs may be communicatively coupled to multiple BSs of the network. The TRPs may be associated with one or more cells. The TRPs may directly communicate with UEs in the network over the air. For multi-TRP transmissions, the network may form clusters of TRPs to serve UEs. For example, one or more BSs may coordinate with each other to schedule a cluster of TRPs to serve a downlink transmission to a UE.

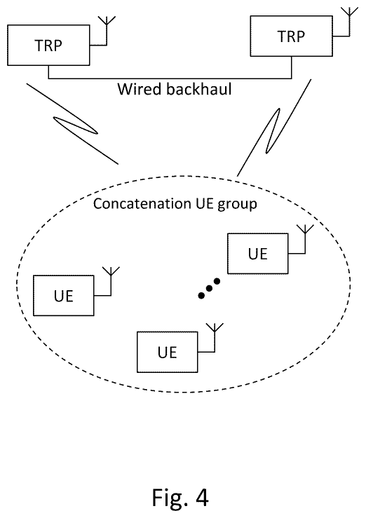

FIG. 4 shows the system architecture. Multi-TRP performs DL data transmission to multiple UEs for URLLC application based packets. For DL transmissions, multi-TRP concatenates multiple packets intended for a group of UEs. Multiple UEs are located for downlink data reception from multi-TRP for URLLC applications. Target UE packets for concatenation are selected based on packet concatenation scheduling. The number of UE groups and multi-TRPs can vary and be adapted.

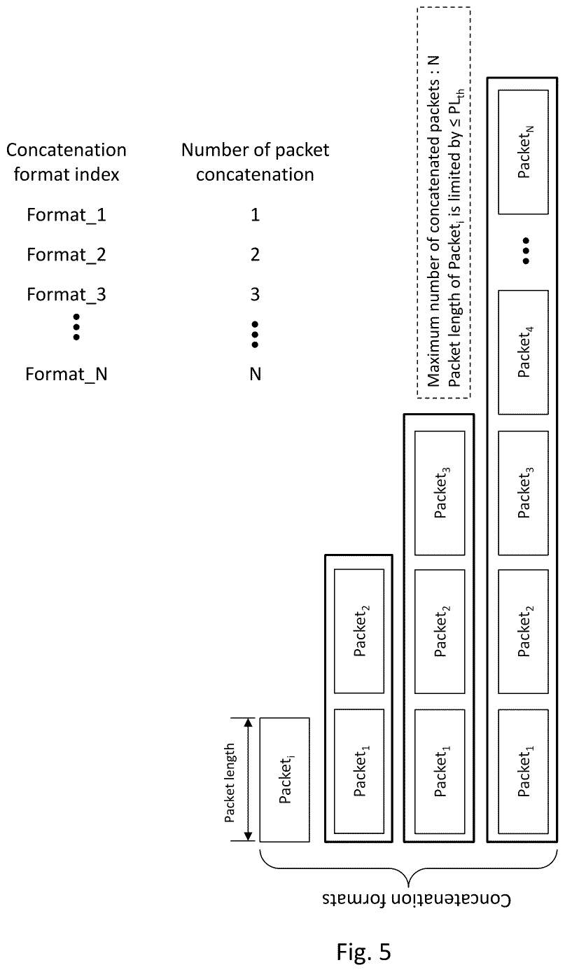

FIG. 5 shows Data Packet Concatenation Format. The solution employs the concept of packet concatenation and our invention is mainly focused on multi-TRP deployment scenario to use concatenation transmission by proposing multiple modes with a combination of TRPs, duplication, and concatenation. For the proposed schemes, the following items are described in detail for support of concatenation transmission mechanism.
1. Concatenation packet format
2. Concatenation scheduling method
3. Multi-TRP based multi-mode concatenation transmissions Also, the required signaling flows and flow charts to support the proposed concatenation mechanism are specified together.

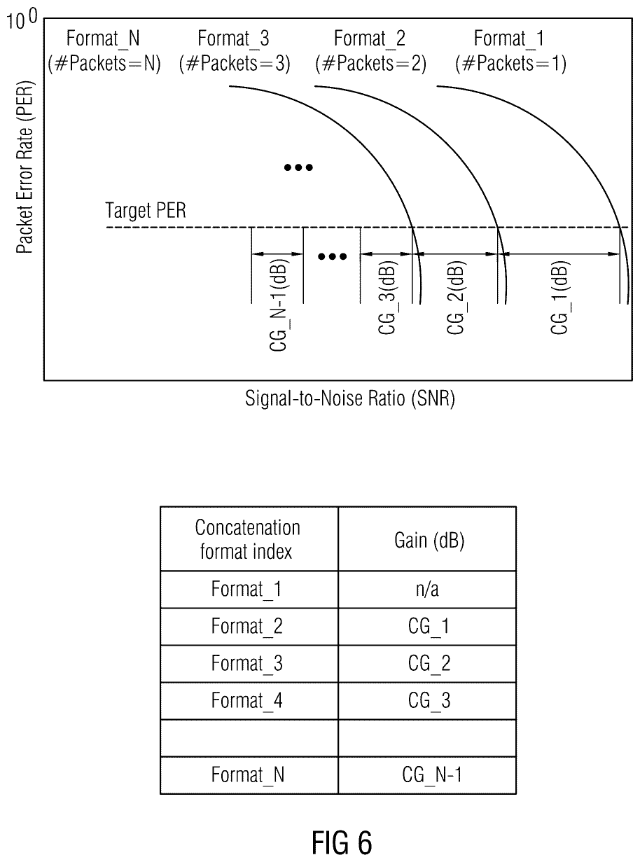

Firstly, for concatenation packet format it needs to be specified to support different numbers of multiple packets and to introduce a new “header” portion to MAC PDU since more than one single packet are concatenated together in the same transport block transmission. As shown below, different concatenation formats are considered based on varying transport block size threshold. Depending on packet traffic type, the parameter set such as packet length constraint and maximum concatenation size can vary. FIG. 6 shows concatenated packet coding gain compensates for use of multi-TRP spatial diversity gain for URLLC UEs and the achievable coding gain depends on #packets and single packet size in concatenation.

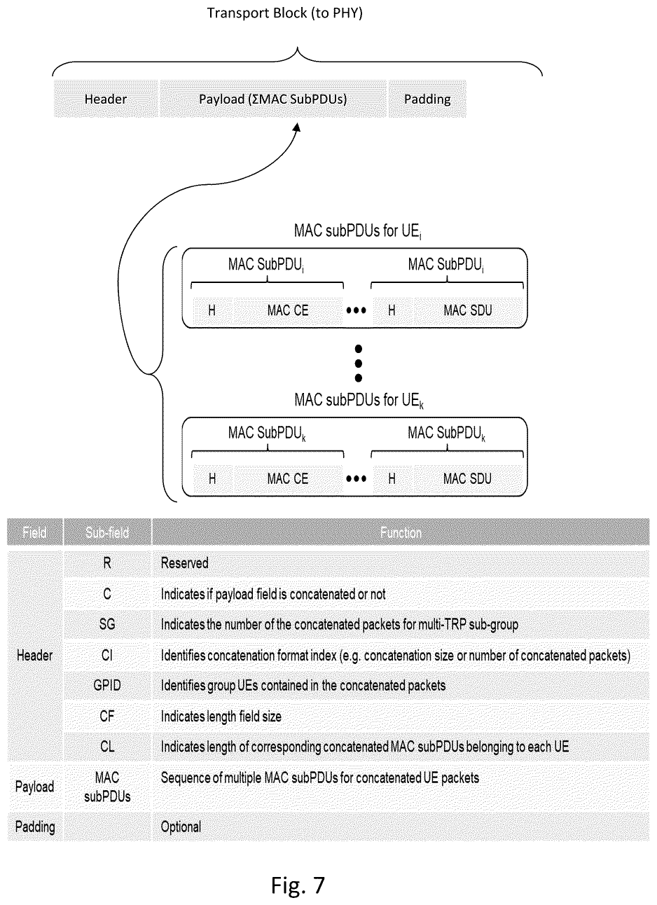

FIG. 7 shows the new MAC PDU structure for packet concatenation with a new defined header for concatenated date packets. The header shown in FIG. 7 provides key information as described in the table below. Hence, the newly added header structure is proposed to be used for 5G and beyond wireless communication network.

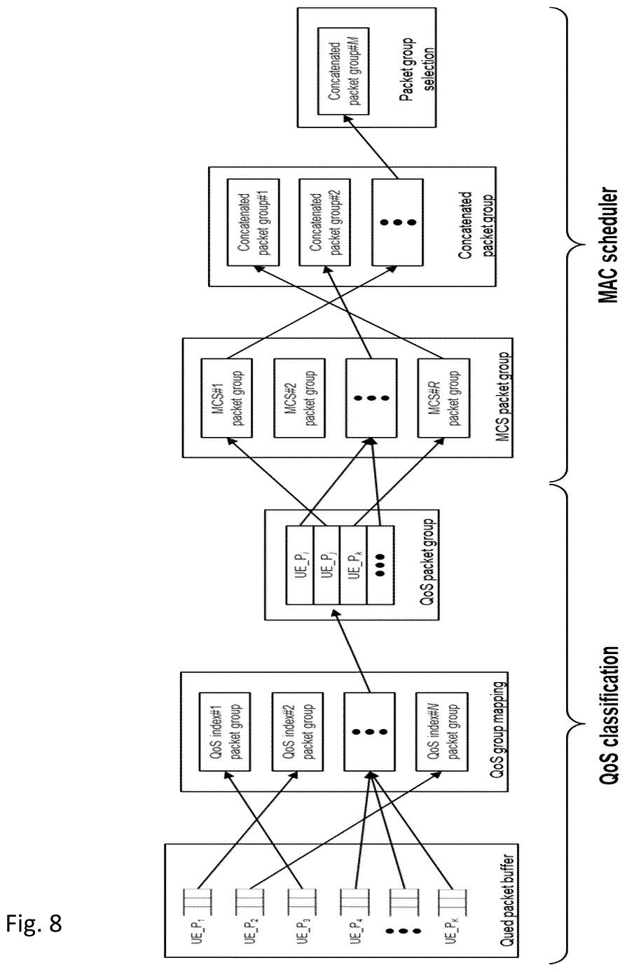

FIG. 8 shows QoS-MAC scheduling method. Concatenation scheduling is another key contribution to the invention as concatenation transmission heavily depends on QoS and MAC layer operations for performance enhancement. Based on the different types of buffered packets in queue for multiple UEs, our invention provides the following important scheduling steps for concatenation transmission.
1. QoS profile index-based packet grouping
2. MCS based packet grouping
3. Concatenated packet selection

QoS profile index: QoS attribute with a set of parameter indications such as
Target data rate
Target error rate
Packet length
Delay budget
Resource type
Priority level
QoS identifier (e.q. 5QI)
Mapping table for Selection criteria (based on QoS profile index)
Packet length range
Max concatenation packet size
Buffer time limit

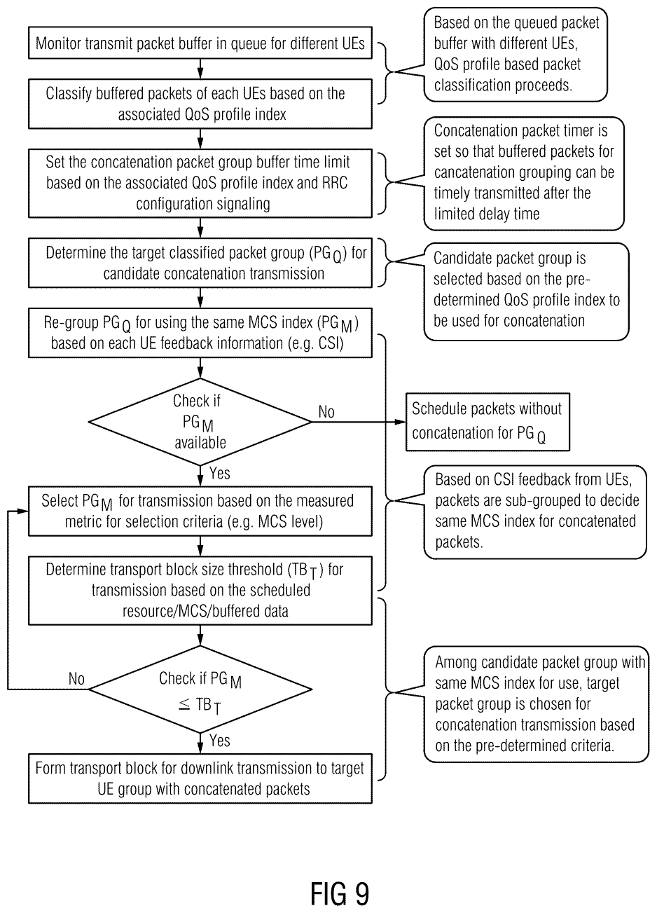

FIG. 9 shows operation flow of QoS and MAC scheduling. Based on different packet grouping and concatenation criteria, the specified parameter set need to be considered based on different types of applications and network conditions. For example, QoS group mapping uses a list of the configured QoS profile index, and it contains different combinations of QoS attribute with a set of parameter indications such as target data rate, target error rate, packet length, delay budget, resource type, priority level, etc. Also, packet group selection can be based on any configured criteria such as packet length range, max concatenation packet size, buffer time limit, priority level, etc.

As for scheduling workflow, the following steps explains details about concatenation process.
Step #1: QoS profile-based packet classification proceeds. This step contains monitoring transmit packet buffer in queue from different UEs and classifying them based on QoS characteristics.
Step #2: Packet concatenation delay time limit is set so that buffered packets for concatenation grouping can be timely processed within the delay time constraint. It is configured based on the target QoS profile index and RRC configuration signaling.
Step #3: Candidate packet group is selected based on the predetermined QoS profile index to be used for concatenation.

Step #4: Based on CSI feedback from UEs, the target classified packet group is sub-grouped to decide same MCS index to be applied for concatenated packets.
Step #5: Among candidate packet group with same MCS index for use, the final packet group is selected for concatenation transmission based on the predetermined criteria.

The flow chart for the above steps is shown in FIG. 9.

FIG. 9 shows the flow chart for the data packet concatenation method. The method comprising the steps, monitoring transmits packet buffer queue for different user equipment (UE), classifying buffered packets of each user equipment (UEs) based on associated quality of service profile index, setting the concatenation packet group buffer time limit by establishing a concatenation packet timer based on the associated quality of service (QOS) profile index and (RRC) configuration signaling, determining the target classified packet group (PG_{Q}) for candidate concatenation transmission, regrouping packet group (PG_{Q}) for using the same modulation coding scheme MCS index (PG_{M}) based on each user equipment (UE) feedback information checking if regrouping packet group (PG_{M}) is available, wherein when regrouping packet group (PG_{M}) is not available scheduling packets without concatenation for regrouping packet group (PG_{Q}) is proceeded, wherein when regrouping packet group (PG_{M}) is available selecting regrouping packet group (PG_{M}) for transmission based on the measured metric for selection criteria is proceeded, determination of transport block size threshold (TB_{T}) for transmission based on the-schedule resource and/or buffered data, checking if regrouping packet group (PG_{M}) is smaller or equals of the block size threshold (TB_{T}) and if regrouping packet group (PG_{M}) is smaller or equals of the block size threshold (TB_{T}) forming a transport block for downlink transmission to target user equipment (UE) group with concatenated data packets.

Selection criteria are Max MCS level, and/or Mmax number of packets in concatenation and/or highest priority level.

During the end-to-end work flow of concatenation process, packet group buffer time also need to be set as time threshold value so that concatenation transmission is complete before this time threshold expires.

Based on the queued packet buffer with different UEs, QoS profile based packet classification proceeds. Concatenation packet timer is set so that buffered packets for concatenation grouping can be timely transmitted after the limited delay time Candidate packet group is selected based on the pre-determined QoS profile index to be used for concatenation. Based on CSI feedback from UEs, packets are sub-grouped to decide same MCS index for concatenated packets. Among candidate packet group with same MCS index for use, target packet group is chosen for concatenation transmission based on the pre-determined criteria.

At the same time, the triggering mechanism is also required for the above concatenation scheduling process for operation. As shown below in the flow chart, radio access traffic load is used to trigger packet concatenation operation and a set of parameter indications can be considered as metric such as data throughput, signaling traffic, packet delay, etc. for any specific QoS profile identification.

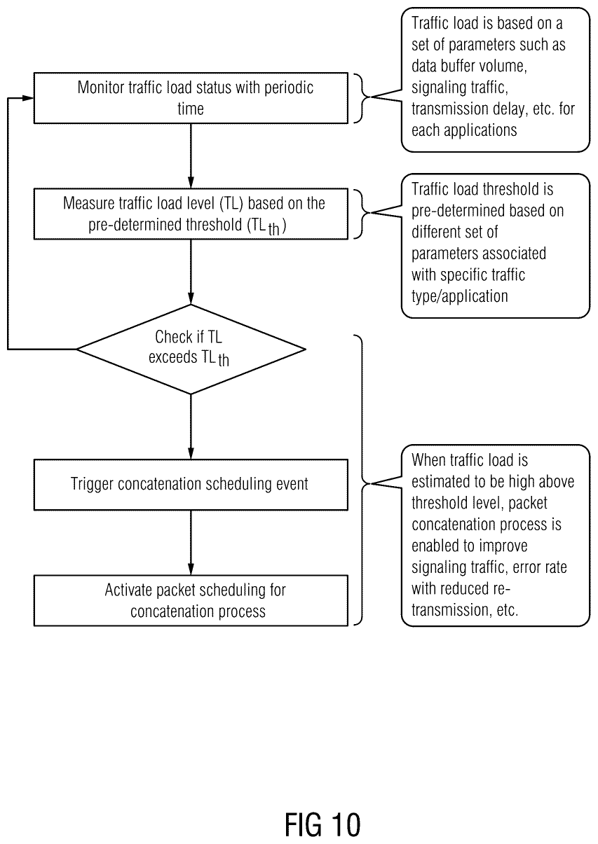

FIG. 10 shows the concatenation triggering flow and shows the steps, which are performed the described following steps. Monitoring traffic load status (TS) with periodic time, measure traffic load level (TL) based on the pre-determined threshold (TLₜₕ), triggering concatenation scheduling event if traffic load level (TL) exceeds pre-determined threshold (TLₜₕ), activating method for concatenating data packets, described in FIG. 12 and according to the claims 8 to 20.

Traffic load is based on a set of parameters such as data buffer volume, signaling traffic, transmission delay, etc. for each application. Traffic load threshold is pre-determined based on different set of parameters associated with specific traffic type/application. When traffic load is estimated to be high above threshold level, packet concatenation process is enabled to improve signaling traffic, error rate with reduced re-transmission, etc. Traffic load Data throughput, signaling traffic, packet delay and jitter.

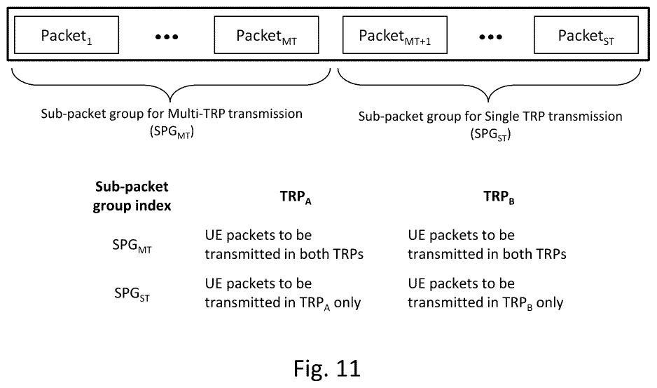

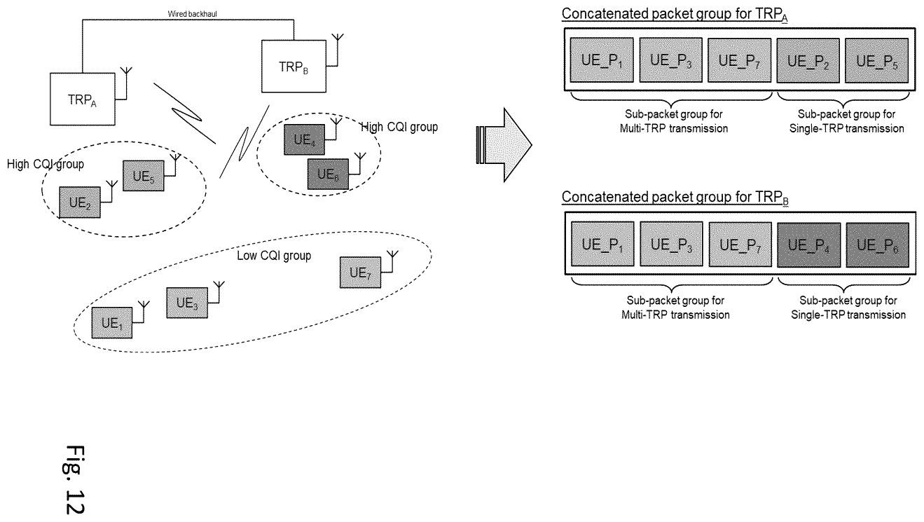

FIG. 11 shows Sub-packet grouping (SPG) for multi-TRP concatenation. In the FIG. 11, packets in SPG_{MT} are transmitted in both TRP_{A} and TRP_{B}. Also packets in SPG_{ST} are transmitted in either TRP_{A} or TRP_{B}. The maximum threshold of sub-packet grouping for SPG_{MT} and SPG_{ST} can be pre-determined with RRC configuration. Criteria of sub-packet group selection are based on CSI feedback information such as CQI, for example, UE packets grouped for SPG_{MT} are for UEs reporting low CQI through PUCCH/PUSCH (CSI report) based on target CQI threshold. UE packets grouped for SPG_{ST} are for UEs reporting high CQI through PUCCH/PUSCH (CSI report) based on target CQI threshold.

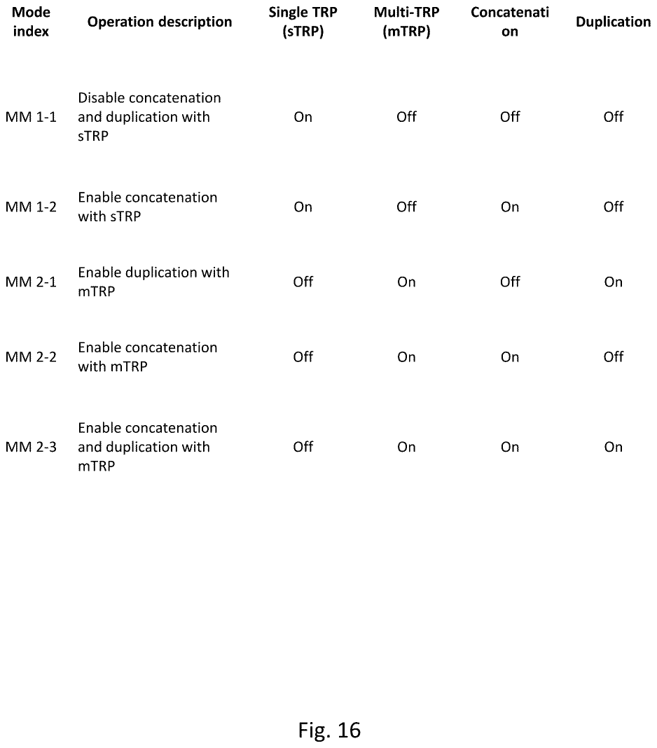

On the other hand, multi-TRP operation is invisible to MAC layer and concatenation functionality is also invisible to PHY layer. Hence, when gNB MAC performs concatenation, it must provide indication to gNB PHY. Based on this indication, gNB PHY can send concatenation packet through multiple TRPs. It should be also noted that radio access network may include multiple TRPs installed at different geographical locations and those TRPs can be linked with multiple gNBs across cells. The flow chart is described in FIG. 16.

Maximum threshold of SPG_{MT} and SPG_{ST} can be pre-determined with RRC configuration. Criteria of selecting between SPG_{MT} and SPG_{ST} are: SPG_{MT}: UE packets listed in MCS packet group that reports low CQI through PUCCH/PUSCH (CSI report) based on target CQI threshold (CQIₜₕ) SPG_{ST}: UE packets listed in MCS packet group not listed in SPG_{MT} based on target CQI threshold (CQIₜₕ).

It has to be mentioned that, UE packets in SPG_{ST} are not duplicated in TRP_{A} and TRP_{B}.

FIG. 12 shows scenario for the transmission method for multi TRP. TRP_{A} and TRP_{B} are connected via a backhaul and are able to receive and transmit information between the user equipments 1-7 (UE₁ to UE₇). The user equipment UE₁, UE₃, and UE₇ belong to the group of UEs belonging to the group of UEs with Low CQI group. The user equipment UE₂, UEs are belonging with the user equipment UE₄, UE₆ to the group with high CQI. As it can be seen in FIG. 15 the concatenated packet group for TRP_{A} is formed by sub-packet grouping for multi-TRP transmission for the packets of UE₁, UE₃, UE₇, as UE_P₁, UE_P₃ and for UE₂, UE₅ as UE_P₂ and UE_P₇ as packet group for single TRP transmission according to registration for TRP_{A}, the concatenated packet group for TRP_{B} is formed by sub-packet grouping for multi-TRP transmission for the packets of UE₁, UE₃, UE₇, as UE_P₁, UE_P₃ and for UE₄, UE₆ as UE_P₄ and UE_P₆ as packet group for single TRP transmission. This is an example of the concatenation based and the CQI feature.

As indicated above, FIG. 12 is provided merely as an example. Other examples may differ from what is described with regard to FIG. 12.

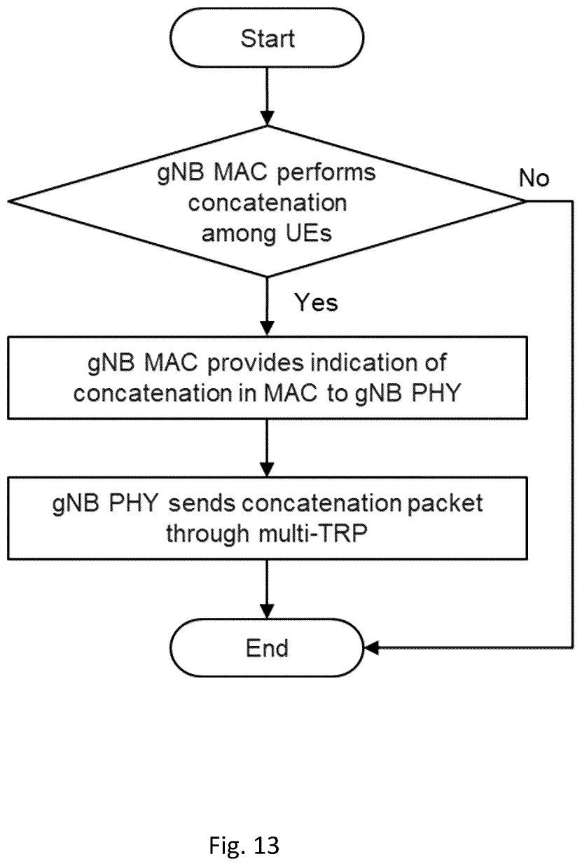

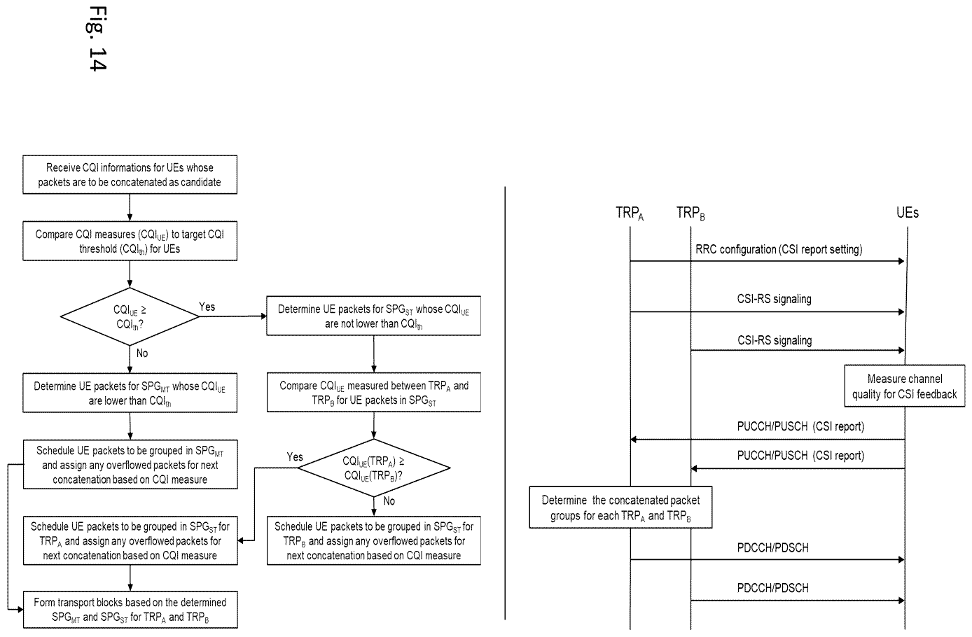

FIG. 13 shows the flowchart for the method for concatenation transmission for ultra-reliable low-latency communication between two layers in a wireless communication system with transmission and receiver points (TRP). The method performs, if base-station for Media Access Control (MAC)-Layer (gNB MAC) performs concatenation among user equipments (UEs), base-station for Media Access Control (MAC)-Layer (gNB MAC) provides indication of concatenation in Media Access Control (MAC) layer to base station for physical-Layer (gNB PHY) and base station for physical-Layer (gNB PHY) sends concatenation packet through multi transmission and receiver points (multi-TRP).

By considering that multi-TRP concept is invisible to MAC layer and concatenation functionality is also invisible to PHY layer, when gNB MAC performs concatenation, it has to provide indication to gNB PHY. Based on this indication, gNB PHY can send concatenation packet through multiple TRPs. Radio access network may include multiple TRPs installed at different geographical locations and those TRPs can be linked with multiple gNBs across cells.

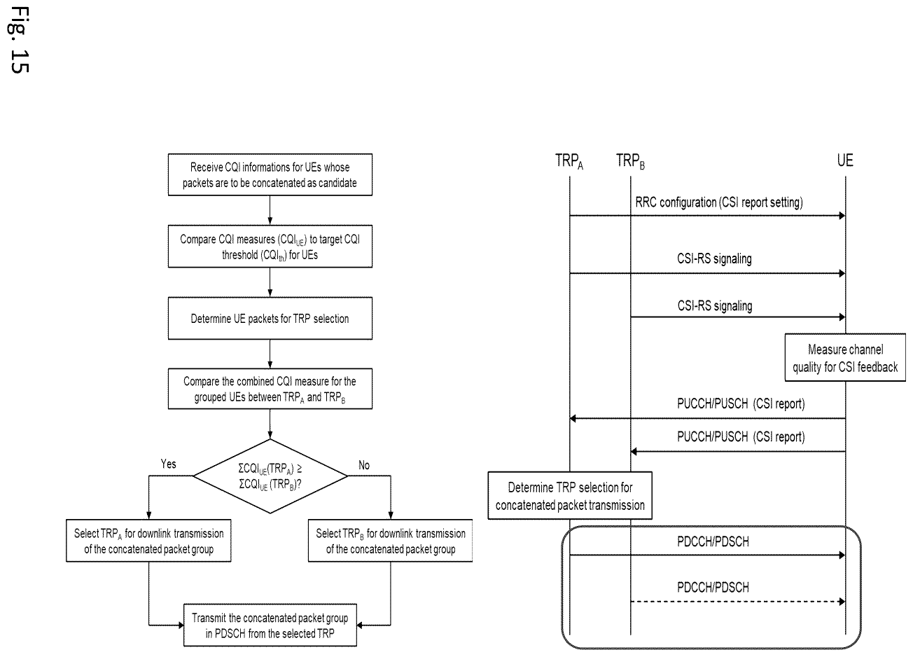

FIG. 14 shows the messaging method for the method for concatenation Transmission method for multi TRP in the depicted flowchart.

FIG. 15 shows the TRP path selection of Multi-TRP for concatenated transmission comprising the steps, receiving channel quality indicator (CQI) information for user equipments (UEs) which are to be concatenated as candidate, comparing channel quality indicator (CQI) measures (CQI_{UE}) to target channel quality indicator (CQI) threshold (CQIₜₕ) for user equipments (UEs), determining user equipment (UE) packets for transmission and receiver points (TRP) selection comparing the combined channel quality indicator (CQI) measure for the grouped user equipments (UEs) between transmission and receiver points (TRP) A (TRP_{A}) and B (TRP_{B}) wherein when the sum of channel quality indicator (CQI) measures (CQI_{UE}) for transmission and receiver points A (TRP_{A}) is higher than CQI measures (CQI_{UE}) for transmission and receiver points B (TRP_{B}), selecting transmission and receiver points A (TRP_{A}) for downlink transmission of the concatenated packet group, otherwise selecting transmission and receiver points A (TRP_{B}) for downlink transmission of the concatenated packet group, transmitting concatenated packet group in Physical Data Shared Channel (PDSCH) from the selected transmission and receiver points (TRP).

FIG. 16 shows the Multi-Mode Concatenation Transmissions modes. The table shown in FIG. 20 describes each transmission modes with different combinations of activation for TRP, duplication and concatenation.

Based on the above table, each transmission modes are briefly explained as follows.
MM 1-1: Only single TRP is activated for use.
MM 1-2: Concatenation is activated, but only for single TRP.
MM 2-1: Duplication is activated with multi-TRP.
MM 2-2: Concatenation is activated with multi-TRP.
MM 2-3: Concatenation and duplication are activated with multi-TRP.

In the above multi-mode concatenation transmissions, various mode switching mechanisms can be applied by using metrics, such as link quality condition, QoS level priority, minimum MCS selection, network traffic condition, etc. Also, it can be configured by higher layer signaling or semi-persistent operation with RRC/MAC CE. The flow chart for multi-mode concatenation transmissions is shown in FIG. 21.

For further details about multi-mode concatenation transmission, the below architecture of sub-packet group-based concatenation is proposed in FIG. 14.

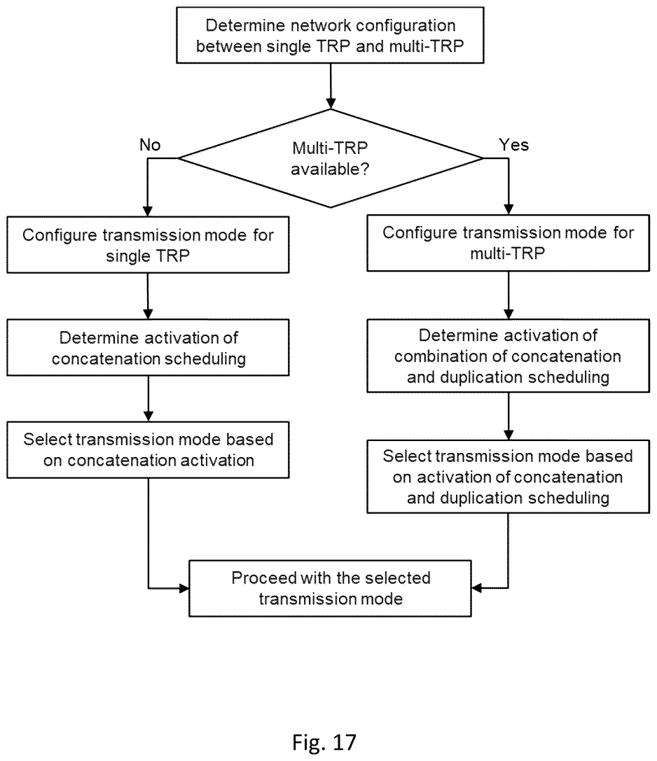

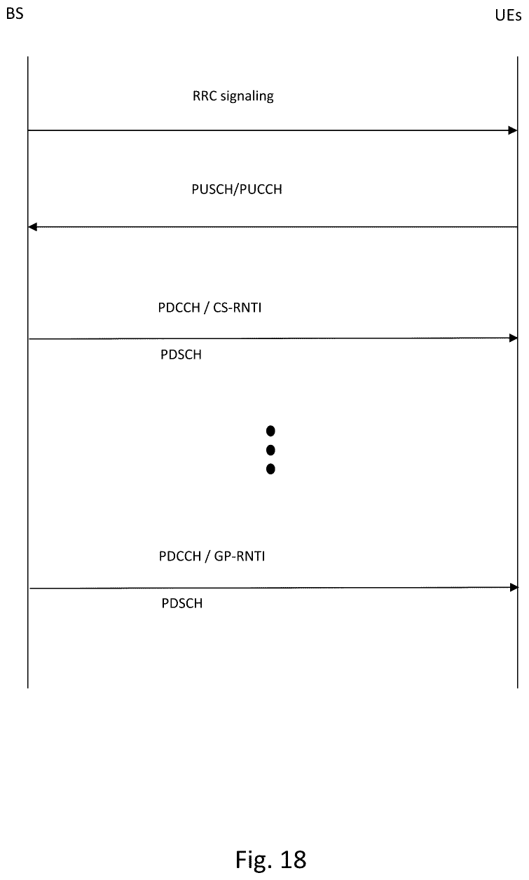

FIG. 17 shows the flow for Multi-Mode Concatenation Transmissions.

In multi-mode concatenation transmission schemes, various mode switching mechanisms can be used, Link quality condition based, QoS level priority based, Minimum MCS selection based, Network traffic condition based etc.

Also mode switching operation can be configured by higher layer signaling or semi-persistent scheduling with RRC/MAC CE.

FIG. 18 shows the configured/dynamic Scheduling Scenarios. In terms of configured/dynamic scheduling flow, UE capability information is monitored to check if concatenation transmission can be received for decoding. For scheduling of concatenated transmission, MAC CE can be used to activate packet concatenation. After concatenation session is complete, the default transmission of unicast mode as non-concatenation is used. The exemplary signaling flow is described below. Here, CS-RNTI is used as CS (configured scheduling) resource allocation with RRC defining the periodicity of the CS grant and GP-RNTI is used as GP (group-concatenated scheduling) to override any previous scheduling for concatenation transmission.

As multi-TRP based data duplication transmission results in signaling traffic overhead increase, the overall network capacity and resource utilization efficiency are impacted at the expense of spatial diversity provided by multi-TRP. By concatenating multiple packets in the same transport block within any given transmit time interval for multi-TRP based transmission, the overall signaling traffic can be significantly reduced for both control and data channels. The amount of signaling traffic overhead reduction depends on the degree of concatenation level and network traffic load conditions. The higher concatenation level provides better signaling traffic condition for radio access network and leads to a signaling traffic overhead reduction.

Short packet transmission helps lower latency, but its reliability performance fundamentally is degraded due to short packet size. Then it requires high SNR to meet low error rate for URLLC applications. The proposed multi-mode concatenation transmission method provides high SNR gain by combining activation of concatenation and duplication of data packets with multi-TRP. Generally spoken this means a reliability performance enhancement.

Multi-TRP based spatial diversity sacrifices additional resource to be used by transmitting the duplicated data through multiple links. However, the proposed multi-mode concatenation transmission method provides better utilization of radio resource based on channel link quality conditions by transmitting mixture of duplicated and non-duplicated data packets in the same transport block within the transmit time interval. Hence, radio resource can be used more efficiently based on the combination of activations for duplication and concatenation transmissions and this means a resource utilization efficiency improvement.

1. An apparatus configured to be employed within a multiple transmission and reception point (multi-TRP) interacting with user equipments (UE) for ultra-reliable low-latency communication in a wireless communication system, comprising one or more processors with at least a memory configured to:
generate a Media Access Control (MAC) protocol data payload comprising a sequence of a set of IP packets (PacketN) for a set of user equipments (UEs), wherein one member of the sequence of a set of IP packets (PacketN) of a set of user equipments (UEs) are a sequence of multiple Media Access Control sub protocol data units (MAC subPDUs) for concatenated user equipment (UE) packets,
attach a MAC header to the MAC data field to generate a packet data unit (PDU), wherein the MAC header indicates, if the Media Access Control (MAC) protocol data payload field is a concatenated payload field.

2. The apparatus according to claim 1, wherein the MAC header indicates the number of the concatenated packets for multiple Media Access Control sub protocol data units (MAC subPDUs).

3. The apparatus according to claim 1, wherein the MAC header indicates a length field size of concatenated payload field.

4. The apparatus according to claim 1, wherein the MAC header indicates length of corresponding concatenated multiple Media Access Control sub protocol data units (MAC subPDUs) belonging to each user equipment (UE).

5. The apparatus according to claim 1, wherein the MAC header identifies concatenation format index.

6. The apparatus according to claim 5, wherein the MAC header identifies concatenation size or number of concatenated packets.

7. The apparatus according to claim 5, wherein the MAC header identifies group user equipment's (UEs) contained in the concatenated packets.

8. A method for concatenating data packets for ultra-reliable low-latency communication in a wireless communication system with transmission and receiver points (TRP), the method comprising:
monitoring transmits packet buffer queue for different user equipment (UE);
classifying buffered packets of each user equipment (UEs) based on associated quality of service profile index;
setting the concatenation packet group buffer time limit by establishing a concatenation packet timer based on the associated quality of service (QOS) profile index and (RRC) configuration signaling;
determining the target classified packet group (PG_{Q}) for candidate concatenation transmission;
regrouping packet group (PG_{Q}) for using the same modulation coding scheme MCS index (PG_{M}) based on each user equipment (UE) feedback information;
checking if regrouping packet group (PG_{M}) is available;
if regrouping packet group (PG_{M}) is not available, scheduling packets without concatenation for regrouping packet group (PG_{Q});
if regrouping packet group (PG_{M}) is available, selecting regrouping packet group (PG_{M}) for transmission based on the measured metric for selection criteria determination of transport block size threshold (TB_{T}) for transmission based on the-schedule resource and/or buffered data; and
checking if regrouping packet group (PG_{M}) is smaller or equals of the block size threshold (TB_{T}) and if regrouping packet group (PG_{M}) is smaller or equals of the block size threshold (TB_{T}) forming a transport block for downlink transmission to target user equipment (UE) group with concatenated data packets.

9. The method according to claim 8, wherein based on the queued packet buffer with different UEs, Quality of Service (QOS) profile based packet classification proceeds.

10. The method according to claim 8, wherein concatenation packet timer is set, that the buffer packets for concatenation grouping is timely transmitted after the limited delay time.

11. The method according to claim 8, that, wherein the candidate packet group (PG_{Q}) is selected based on the pre-determined quality of service profile index to be used for concatenation.

12. The method according to claim 8, wherein the feedback information is Chanel State information (CSI).

13. The method according to claim 8, wherein the selection criteria are the Modulation Coding method (MCS).

14. (canceled)

15. (canceled)

16. The method according to claim 8, wherein the selection criteria is a highest priority level.

17. The method according to claim 8, wherein the selection criteria is the maximum of Modulation Coding Scheme (MCS) level.

18. The method according to claim 8, wherein the selection criteria are maximum number of packets in concatenation.

19. The method according to claim 8, wherein among candidate packet group with same modulation coding scheme (MCS) index for use, target packet group is chosen for concatenation transmission based on the pre-determined criteria.

20. The method according to claim 8, wherein a packet group buffer time is set as time threshold value to secure that concatenation transmission is complete before this packet group buffer time threshold expires.

21. A method for triggering a concatenated transmission for ultra-reliable low-latency communication in a wireless communication system with transmission and receiver points (TRP), comprising:
monitoring traffic load status (TS) with periodic time;
measure traffic load level (TL) based on a pre-determined threshold (TLₜₕ);
triggering concatenation scheduling event if traffic load level (TL) exceeds pre-determined threshold (TLₜₕ);
concatenating data packets by:
monitoring transmits packet buffer queue for different user equipment (UE);
classifying buffered packets of each user equipment (UEs) based on associated quality of service profile index:
setting the concatenation packet group buffer time limit by establishing a concatenation packet timer based on the associated quality of service (OoS) profile index and (RRC) configuration signaling;
determining the target classified packet group (PG_{Q}) for candidate concatenation transmission;
regrouping packet group (PG_{Q}) for using the same modulation coding scheme MCS index (PG_{M}) based on each user equipment (UE) feedback information;
checking if regrouping packet group (PG_{M}) is available;
if regrouping packet group (PG_{M}) is not available, scheduling packets without concatenation for regrouping packet group (PG_{Q});
if regrouping packet group (PG_{M}) is available, selecting regrouping packet group (PG_{M}) for transmission based on the measured metric for selection criteria determination of transport block size threshold (TB_{T}) for transmission based on the-schedule resource and/or buffered data; and
checking if regrouping packet group (PG_{M}) is smaller or equals of the block size threshold (TB_{T}) and if regrouping packet group (PG_{M}) is smaller or equals of the block size threshold (TB_{T}) forming a transport block for downlink transmission to target user equipment (UE) group with concatenated data packets.

22. The method according to claim 21, wherein traffic load status is based on the data buffer volume and/or signaling traffic and/or transmission delay.

23. (canceled)

24. (canceled)

25. (canceled)

26. (canceled)

27. (canceled)

28. (canceled)

29. (canceled)
